(19) United States
(12) Patent Application Publication
(10) Pub. No.: US 2021/0136072 A1
(43) Pub. Date: May 6, 2021

(54) AUTOMATED PROVISIONING FOR ACCESS CONTROL WITHIN FINANCIAL INSTITUTIONS

(71) Applicant: EXCLAMATION GRAPHICS, INC. d/b/a EXCLAMATION LABS, Cumberland, MD (US)

(72) Inventors: Jonathan HUTCHERSON, Cumberland, MD (US); David Andrew COPE, Cumberland, MD (US); Brandon POWERS, Cumberland, MD (US)

(73) Assignee: EXCLAMATION GRAPHICS, INC. d/b/a EXCLAMATION LABS, Cumberland, MD (US)

(21) Appl. No.: 17/085,461

(22) Filed: Oct. 30, 2020

Related U.S. Application Data
(60) Provisional application No. 62/928,167, filed on Oct. 30, 2019.

(51) Int. Cl. H04L 29/06; G06N 20/00; H04L 29/08

(52) U.S. Cl. CPC H04L 63/0884; G06N 20/00; H04L 67/34; H04L 63/102; H04L 63/0892

(57) ABSTRACT

Methods, systems, and apparatus, including computer programs encoded on computer storage media, for SaaS-based provisioning access control for an entity are disclosed. A request to provision an external system of an entity through an identity access management engine may be received. Credentials to connect the external system of the entity with a provisioning engine of the identity access management engine may be acquired. Data fields and structures from the external system may be identified. Mappings of the data fields and/or related structures from the external system of the entity to data fields and/or related structures of the identity access management engine may be created using a user interface. Identities may then be imported from the external system to the identity access management engine using the created mappings.

### CROSS REFERENCE TO RELATED APPLICATIONS

This non-provisional application claims the benefit under 35 U.S.C. § 119(e) to U.S. Provisional Application No. 62/928,167, filed on Oct. 30, 2019, all of which are hereby expressly incorporated by reference into the present application.

### BACKGROUND

This specification relates to automating access provisioning for financial institutions using software as a service.

Financial institutions often manage hundreds of systems. Each system must control user privileges, with varying permissions, to ensure security. In each system, users have different privileges, roles, and responsibilities. Users may even belong to groups that each have a special set of privileges, assignments, or duties. All of these rights, permissions, and responsibilities are usually managed with access control and are traditionally tracked using spreadsheets or legacy systems. Due to personnel turnover, hiring, and role changes, access control on every system generally needs to be updated frequently through manual processes. Although system managers and administrators are diligent, managers and administers occasionally miss critical access control changes, leaving security holes in important financial systems that are open to unauthorized users and hackers.

### SUMMARY

This specification describes technologies for managing access to multiple external systems using automated processes and a provisioning system. These technologies generally involve a single, automated source that has a user-interface based workflow to provision multiple different types of record-keeping systems to a central identity access management engine so that access to financial institution systems can be centrally managed.

In general, one innovative aspect of the subject matter described in this specification can be embodied in methods that include an identity access management system that provides breach protection and audit-ready documentation.

The foregoing and other embodiments can each optionally include one or more of the following features, alone or in combination. In particular, one embodiment includes all the following features in combination.

The subject matter described in this specification can be implemented in particular embodiments so as to realize one or more of the following advantages.

An example provisioning system provides financial institutions with a cloud-based software as a service (SaaS) access control solution that allows the financial institutions to centralize their record keeping applications, making access control more robust and easier to facilitate. Customary systems require manual input from users to map groups, roles, and responsibilities (collectively referred to as permissions) from a financial institution's multiple systems to a single central identity access management engine. The provisioning system of this specification provides an automated way to map these permissions.

The provisioning system includes an easy-to-use user interface that walks an administrator through system setup and allows the administrator to connect a financial institution's systems with a central identity access management engine, requiring very little or no programming. The provisioning system connects to the financial institution's various systems and determines how to assign rights and responsibilities of users so that all the systems can be managed in a central location. Since most of the process is automated, the provisioning system can provide 5-6 times the reduction in time to centralize identity data as compared to customary systems. The provisioning system can also record permission grants and denials, track access to system resources, and control authorized access of each system user. This access control and record logging provides breach protection for financial systems and their data. The system can also guarantee access control integrity, making financial institutions audit-ready.

On a user interface of the provisioning system, a field mapping interface allows an administrator (or other user) to map fields from the financial institution's systems to the central identity access management engine in real time. This mapping can be simple, e.g., field to field, from a template, e.g., the financial system may include a middle name and the central identity access management system may only use a middle initial so every mapping from middle name to middle initial includes using the first letter of the middle name and a period, or complex, e.g., a user may specify that two fields from the financial system are combined into one field of the central identity access management engine. These options allow user flexibility in real time regarding how fields are mapped from one system to another.

A role mapping interface of the provisioning system provides administrators (or other users) with a way to provision access and roles for different system users and groups from a financial system to a central identity access management engine. In one implementation, roles and permissions can be organized, e.g., dragged and dropped, under different users to give and take away permissions from a user, or groups of users.

The provisioning system also provides a method for matching unique identifiers using artificial intelligence to import and match data fields between a financial system and a central identity access management engine.

Once fields, roles, and identifiers have been matched and mapped, the provisioning system allows users to review the mappings and make changes before mapping current users and resources and using the mappings for future users and resources. The provisioning system also includes rollbacks of resource and data mappings and identity management so that mistakes can be corrected.

In addition to making access control easier, the provisioning system can also preconfigure and automatically deploy virtual machines based on customized user responses regarding access control needs to provide access to the central identity management engine.

To support internal provisioning for on-premise applications, the system can preconfigure a self-hosted virtual machine which is installed by the user into their environment. This machine will connect to internal systems that the SaaS application cannot reach directly and create a secure encrypted tunnel to communicate provisioning information back to the central identity access management engine.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example provisioning system.

FIG. 2 is a flowchart of an example process for provisioning access from an entity to an identity access management engine.

FIG. 3 illustrates a user interface for creating an account within a provisioning system.

FIG. 4A illustrates a user interface for choosing an external system of an entity that should be managed by the identity access management engine.

FIG. 4B illustrates an example user interface for entering credentials for an external system of an entity.

FIG. 5 illustrates a field mapping user interface to map fields from an external system to an identity access management system.

FIG. 6A illustrates a user interface for confirming job titles and organizational structures in an external system.

FIG. 6B illustrates the user interface of FIG. 6A with structural reorganization.

FIG. 7 is an example of a role mapping user interface.

FIG. 8A is an example onboarding user interface for confirming imported job titles from an external system.

FIG. 8B is an example onboarding user interface for confirming identities imported from an external system.

FIG. 9A illustrates a user interface for entering credentials for an entity's access controlled system.

FIG. 9B is an example onboarding user interface for confirming users from an external system.

FIG. 9C is an example onboarding user interface for confirming groups from an external system.

FIG. 10 is an example dashboard user interface of a provisioning system.

FIG. 11 illustrates an example system for automated deployment of virtual machines for a central identity access management engine.

FIG. 12 illustrates an example sign up flow for a provisioning system.

FIG. 13 illustrates an example resource creation flow of a provisioning system.

FIG. 14 illustrates an example identity review flow of a provisioning system.

FIG. 15 illustrates an example entitlement review flow of a provisioning system.

FIG. 16 illustrates an example role mapping flow of a provisioning system.

Like reference numbers and designations in the various drawings indicate like elements.

### DETAILED DESCRIPTION

An example provisioning system provides financial institutions with a cloud-based software as a service (SaaS) access control solution that allows the financial institutions to centralize their record keeping applications, making access control more robust and easier to facilitate. The cloud-based SaaS access control solution may be on-demand or subscription based to meet customer needs.

The provisioning system provides connectors, e.g., application programming interfaces (APIs), to connect financial institutions' external systems with a central identity access management engine. Administrators and/or managers from these financial institutions can use a simple user interface that connects to the connectors to establish automated account provisioning of external systems through the central identity access management engine. This process can keep identities, resources, and privileges current in nearly real-time among external systems of an entity and an identity access management engine.

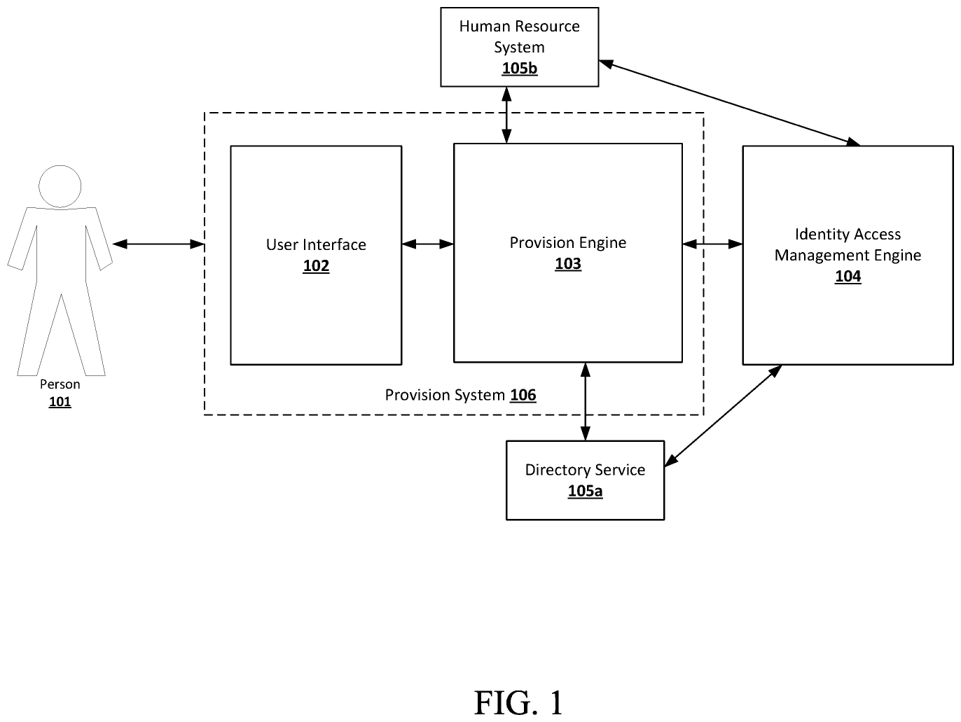

FIG. 1 shows an example system provisioning system 106. This system can map external systems, e.g. directory service 105a and human resource system 105b, of an entity, e.g., a financial institution, to a central identity access management engine 104. External systems can include, for example, directory services, e.g., Active Directory, Sun Java System Directory Server, IBM Tivoli Directory Server, Microsoft Exchange, Office 365, FIS IBS Insight, CMSe, FIsery WireXchange, FIsery CheckFree, Sharepoint, Box, Salesforce, LDAP, and Samba. The external systems may also include human resource systems, e.g., ADP and Ceridian Using a user interface 102, a person 101, e.g., a manager or administrator, can set up an entity's external systems to integrate with the central identity access management engine 104, e.g., MidPoint by Evolveum. Additionally, in some implementations, a manager or administrator can manage user access to the external systems using this user interface 102. In some implementations, end-users can view their own privileges, rights, and responsibilities within external systems of the entity.

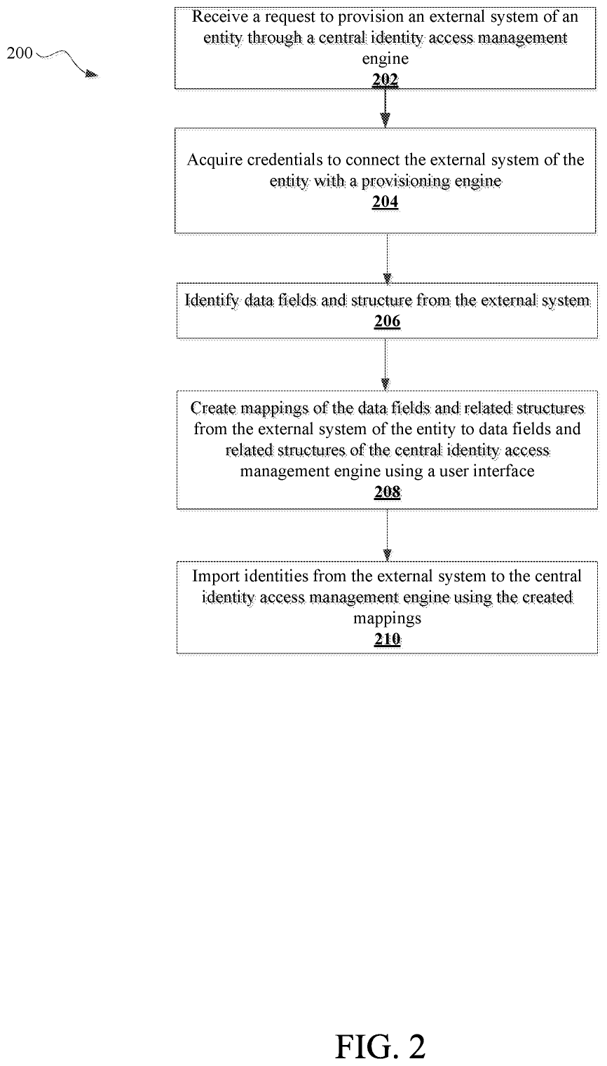

FIG. 2 is a flowchart of an example process 200 for provisioning access from an entity's external system to an identity access management engine 104. For convenience, the process 200 will be described as being performed by a system of one or more computers, located in one or more locations, and programmed appropriately in accordance with this specification. For example, a provisioning system, e.g., the provisioning system 106 of FIG. 1, appropriately programmed, can perform the process 200. The system receives a request to provision an external system, e.g., a human resource system, of an entity, e.g., a local bank, through an identity access management engine (202). The provisioning system then acquires credentials to connect the external system of the entity with a provisioning engine (204). The provisioning system uses the credentials to identify data fields and related structures from the external system (206). The provisioning system then provides a visual display to create mappings of the data fields and related structures between the external system and data fields and related structure of the central identity access management engine using a user interface (208). The system then imports identities from the external system to the identity access management engine using the created mappings (210).

The provisioning system can import all identities, e.g., names, roles, groups, job titles, departments, organizations, locations, email addresses, from the external system. Importing the identities may include acquiring data fields and associated related structures of the data fields from an external system. Once the fields and related structures of an identity are acquired, the system may map the data fields and structures between the external system and the identity access management engine using the created mappings. In some implementations, the system may have default inbound mappings between fields or structures. For example, there may be default inbound mappings for username formats, e.g., first initial+last name or first name+last name. External users and mappings may be displayed in a user interface so that a system administrator or manager can review the mapped information for correctness and completeness. If correct, the information can be confirmed. If incorrect, the information can be edited or reimported.

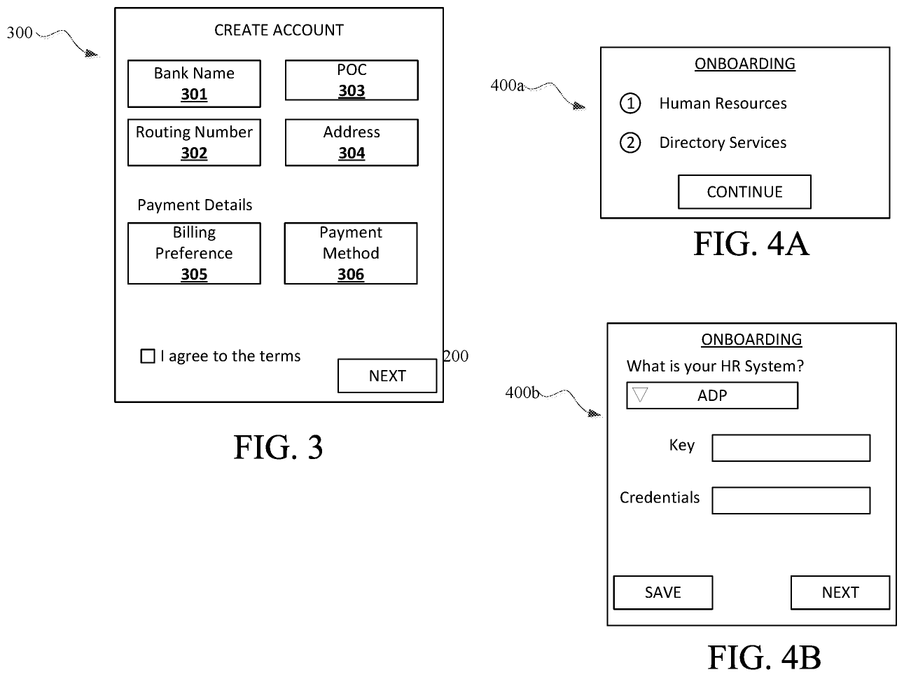

FIG. 3 illustrates a user interface for creating an account within an example provisioning system. A manager or a system administrator accesses the creation user interface, e.g., through a web page or application, of the provisioning system 106. The user provides entity information for the entity which will have its access control managed by an identity access management engine. In one example implementation, as illustrated in FIG. 3, the entity may be a financial institution. Account information may include bank name 301, routing number 302, a point of contact 303, an address of the point of contact 304, and billing information 305, 306 in order to pay for the access management. After the initial information is input, the provisioning system 106 moves the user to the next user interface for easy onboarding, i.e., adding external systems and users of an entity to be managed by an identity access management engine 104.

FIGS. 4A and 4B illustrate user interfaces for an onboarding process of the provisioning system. FIG. 4A illustrates a user interface 400a for choosing an external system of the entity that should be managed by the identity access management engine. As illustrated, in one implementation, a user may choose an external system such as a human resources system, e.g., ADP, or a directory services system, e.g., active directory, or directory services. After choosing an external system, the provisioning system can have the user, e.g., manager or administrator, provide keys and credentials to the chosen system so that data from the systems can be accessed and imported into the identity access management engine.

FIG. 4B illustrates an example user interface 400b for entering credentials for an entity's external system that will be provisioned by the provisioning system. As illustrated, this user interface may allow a user to choose the name of a specific system, e.g., a human resource system, from a list of systems, or type in the name of external system. The user interface then asks the user for credentials to login to the specified system.

For example, for an Active Directory system, a manager or administrator may provide an LDAP host name, a port, a base context, a bindDn, a connection security, and a bind password. For an Office 365 external system, a person may provide an apiEndPoint, a tenancy, a symmetric key, an authentication URL, a principal ID, a resource ID, and an acs Principal ID. For a Microsoft Exchange external system, a person may provide a directory administrator name, a directory administrator password, an object class, a container, whether or not a home directory should be created, an LDAP host name, whether or not child domains should be searched, a domain name, and an exchange URI. The provisioning system may provide the fields necessary for other external systems to be able to connect to a central identity access management engine through the provisioning system. In some implementations, the provisioning system will allow a user to specify the fields. Depending on the external system chosen, the user interface fields can dynamically change to allow a user to input required information regarding external system credentials and set up. The user chooses from a list of common systems and the input fields will change depending on the user's selection in order to ascertain system-specific information.

The provisioning system then identifies data fields and related structures from the specified external system. These data fields and structures can be compared with data fields and related structures of the identity access management engine to determine how to map the data from one system to the other.

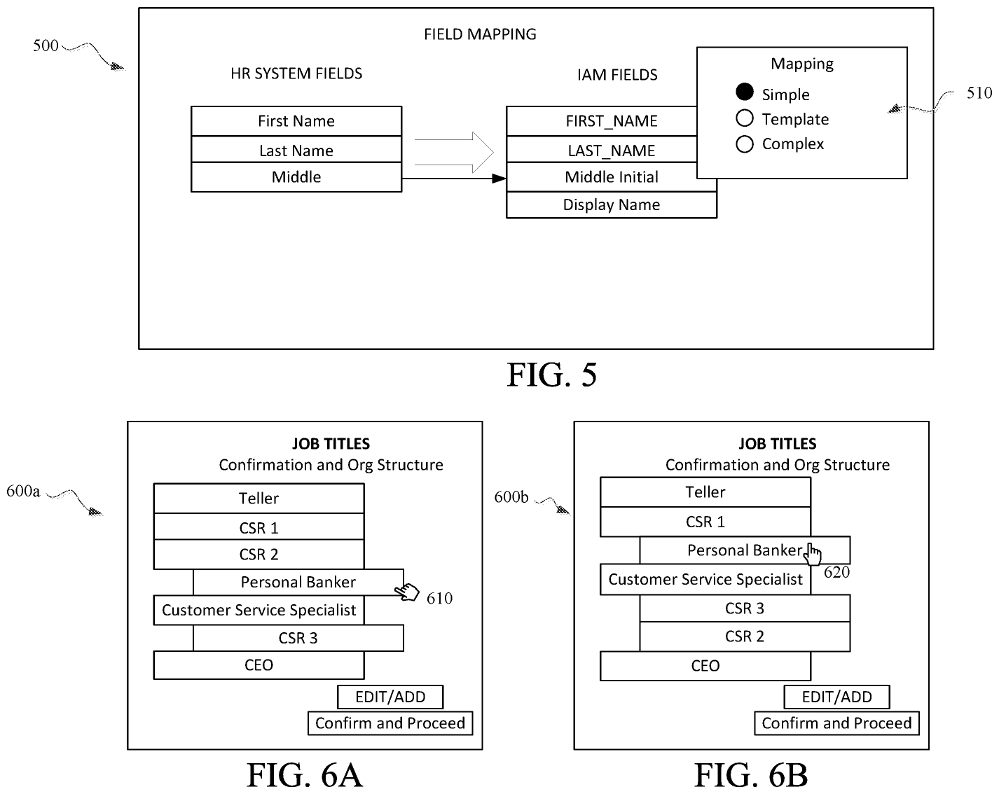

FIG. 5 illustrates a field mapping user interface to map data fields from an external system to an identity access management engine. In an implementation, the fields may be mapped using simple mapping, complex mapping, or a template 510. As illustrated in FIG. 5, a first name field from the HR system may simply be mapped to a first name field of the central identity access management engine. A last name field may also just be simply mapped from one system to the other. However, as illustrated, the HR system includes a middle name field whereas the central identity access management engine has a middle initial field. Simply mapping these fields will not result in correct data being mapped.

In one implementation, a user can use a template that maps the first letter of a user's middle name from the HR system to the middle initial field of the identity access management engine. In another implementation, a user may use the user interface to create a complex mapping from the first letter of the middle name from the HR system to the middle initial of the identity access management engine. Other examples of complex mapping include mapping multiple fields of the external system to one field of the identity access management engine or vice versa. Complex mapping may format fields differently from one system to the other or have other rules to combine or map fields. For example, a user may be able to enter scripting language code to perform functions, e.g., truncate data to x many characters or map a sequence placeholder to enforce field uniqueness.

In an implementation, the provisioning system may use artificial intelligence to detect and determine data fields or structures of the external system to map to specific fields or structures of the identity access management engine. After determining the mapping, the provisioning system may automatically provide the mapping, which can be displayed in a user interface for user review. Artificial intelligence may determine the type of data in a field using machine learning or rule-based techniques. Based on the determined type of data, the provisioning system may determine the field or fields to which to map the field. The provisioning system can also use machine learning or rule-based techniques to determine how the fields and/or related structure of the external system should map to fields and related structure of the identity access management engine. In some implementations, artificial intelligence may also be used to recognize patterns in the field matching and then suggest automation of the pattern. For example, the system may be able to determine that a user has matched fields of an external system to the provisioning system in a specific way, e.g., the user may match an identification field, e.g., internal worker ID, and then secondarily a last name field, and finally truncated a first name field to 6 characters. Once the system recognizes the specific pattern, the system can prompt the user to have the system handle all records from the external system using the same pattern. For example, the system may prompt the user with “I notice that you've been matching on the internal worker ID, then secondarily the last name, and then truncating the first name at 6 characters. Would you like to have me automatically follow the same pattern for the remaining 211 records and then have you approve?”

In addition to names, an example user interface may allow a user, e.g., a system manager or administrator, to map other information including job titles, departments, organizations, roles, or locations. The organization structure of departments and jobs that fall under each department may also be mapped. In some implementations, information such as a user's department and location and organizational structure can be edited within the user interface and then mapped to data fields and/or structure of the identity access management engine. In other implementations, the information should be updated in the original source location of the information, e.g., the human resource system from which the information comes, and reviewed in the user interface. After mapping the fields and related structures, identities from the specified external system may be imported into the identity access management engine.

FIG. 6A is an example onboarding user interface for confirming imported job titles and organization structure from an external system 600a. The imported data can be mapped based on created mappings or automated mappings between the external system and the central identity access management engine. The data can be confirmed, refreshed from the external system, or in some cases, corrected on the user interface. A system user may be able to add new job titles, change existing titles, add new organizational structure, and rearrange or change organizational structures from this user interface.

For example, as illustrated in FIG. 6A, a job of customer service representative 2 (CSR2) has the role of “Personal Banker” underneath it. FIG. 6B illustrates the onboarding user interface of FIG. 6A with part of the organizational structure rearranged. In FIG. 6B the role of “Personal Banker” moved from underneath CSR2 to under customer service representative 1 (CSR1). This change can be made, for example, simply by clicking on the respective role to be moved and dragging the role to a new location. In one implementation, as illustrated, the user interface allows a system user, e.g., an administrator or manager, to drag and drop or otherwise rearrange the structure of job titles and organizational infrastructures right within the user interface.

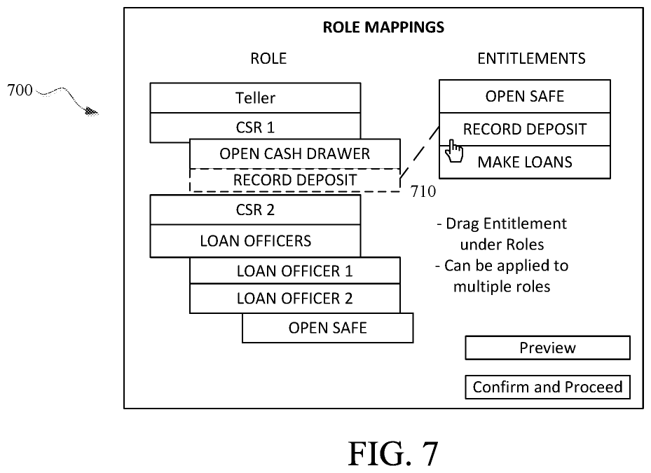

FIG. 7 is an example of a role mapping user interface. As illustrated, entitlements, e.g., resources or permissions, can be dragged and dropped under certain roles. For example, in FIG. 7, the entitlement record deposit 710 can be added, e.g., dragged and dropped, under the role CSR1. Each entitlement can be added to multiple roles. In one implementation, person, e.g., a manager or system administrator, can use a separate user interface to add or delete certain roles and/or entitlements. Once a role is given one or more entitlements, any user associated with a role in the provisioning system will have one or more entitlements assigned to the role. For example, as illustrated, any user associated with the role CSR1, will have the ability to open the cash drawer and record deposits since those are the entitlements provided to the CSR1 role.

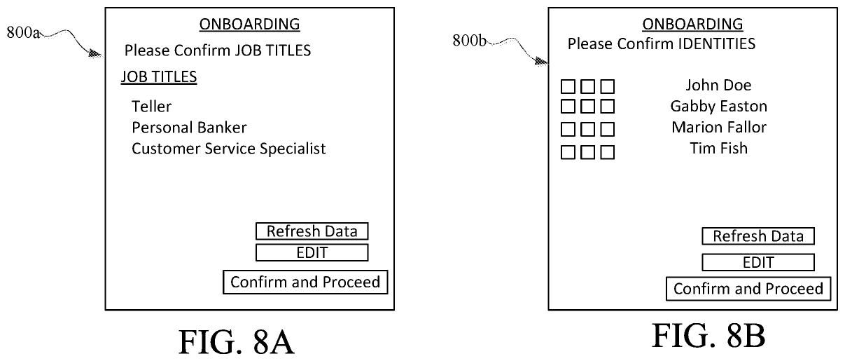

FIG. 8A is an example onboarding user interface for confirming job titles and organizational structures to be imported from an external system 800a. In addition to confirming the completeness and accuracy of the job titles and organizational structures, a system user, e.g., an administrator or manager, may also be able to add new job titles, change existing titles, and rearrange or change organizational structures from the user interface as disclosed above with respect to FIGS. 6A and 6B.

FIG. 8B is an example onboarding user interface for confirming identities imported from the external system 800a. As illustrated, checkboxes may allow a user to flag accounts that should be tagged as service accounts, administrative accounts, or ignored. As with job titles, the imported data can be confirmed, refreshed from the external system, or in some implementations, corrected on the user interface.

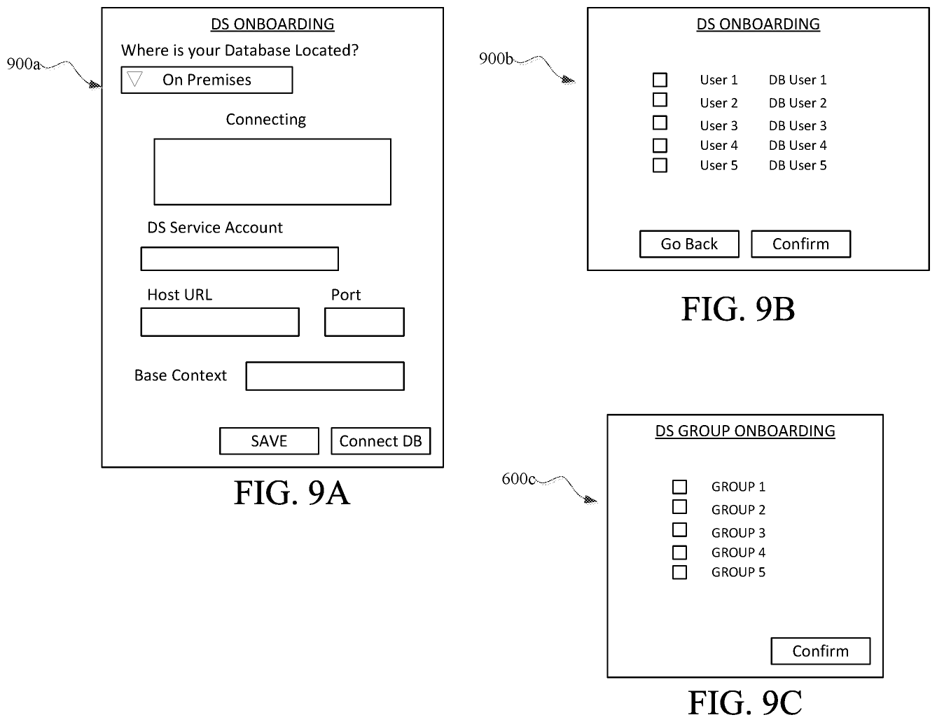

FIGS. 9A-9C illustrate another part of the onboarding process. A user may use the user interface of FIG. 4A to choose a directory service, e.g., Active Directory or LDAP, of the entity that should be managed by the central access identity management engine. As illustrated in FIG. 9A, a user interface may walk a user through providing information and credentials to connect the external system to the central access identity management engine 900a. For example, a user may enter information including: connecting information, a service account number, a host url, a port number, a base context, and the location of the external system. Other fields may be present depending on the system being configured. A database may be located in the cloud, e.g., accessed through Azure or some other cloud-based service, or located on the premises of the person or organization, e.g., a financial institution, using the database and the provisioning system 106, rather than at a remote facility. As illustrated in FIG. 6A, “on the premises” has been selected for where the database is located. If the database is located on the premises, the provisioning system may create a virtual machine to access the database. A user, e.g., a system administrator, may configure a provisioning system account in the database, so that this provisioning system account can access the database. The system can preconfigure a self-hosted virtual machine which is installed by the user into their environment. This machine will connect to internal systems that the SAAS provisioning application cannot reach directly and create a secure encrypted tunnel to communicate provisioning information back to the central identity access management engine.

FIG. 9B is an example onboarding user interface for confirming identities, e.g., users, from an external system 900b. The provisioning system imports identities from the external system, e.g., active directory, and confirms the identities that should be imported into the central identity access management engine. These identities can be selected or deselected from this user interface.

FIG. 9C is an example onboarding user interface for confirming groups from an external system. Using this interface, a user may be able to select or deselect groups to import into the identity access management engine.

Once all the information from the external systems has been reviewed and confirmed, the provisioning system imports data from external systems into the central identity access management engine. The data is stored and managed through the identity access management engine as illustrated in FIG. 1.

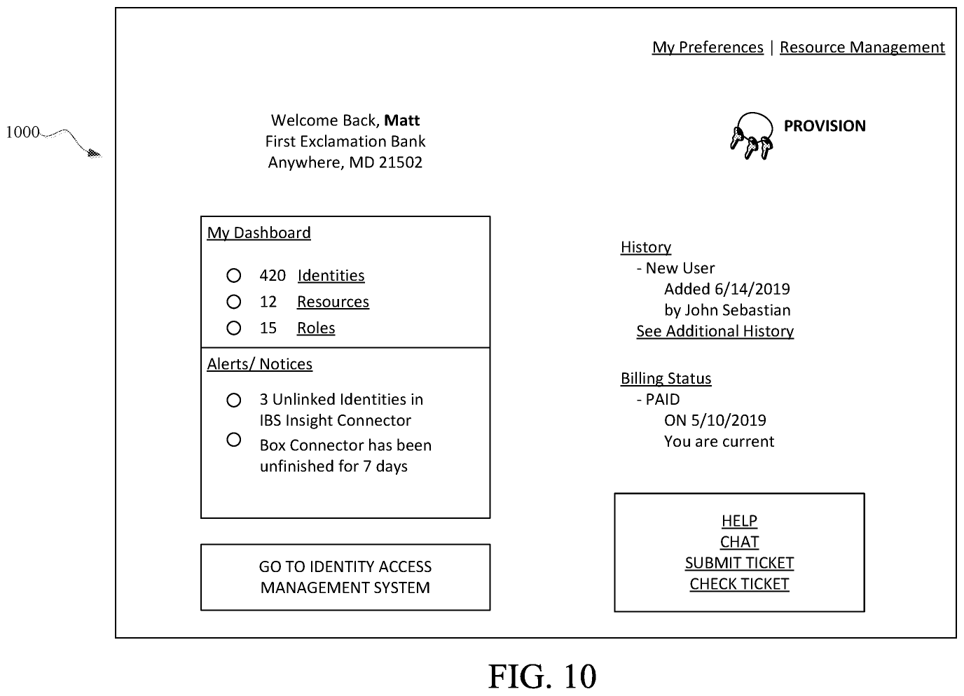

FIG. 10 is an example dashboard user interface of the provisioning system. This dashboard shows an administrator or manager the identities, roles, and resources that the system is managing for the administrator or manager. The dashboard also provides alerts and notices for the administrator's or manager's attention. For example, as illustrated the dashboard may alert the user to errors in the system. The dashboard may also provide information about users that have been added, modified, or deleted or other modifications to the system. The dashboard may also provide a way for administrators or managers to create or change user roles and privileges.

In some implementations, any additions, modifications, or deletions made from the provisioning system are logged so that the system has a record of these actions. System administrators or managers may also be notified about any changes to data using the provisioning system. By providing logs and notifications, the system can maintain data integrity and provide an accounting of all privileges, roles, and assignments to an entity's external systems. The provisioning system can be viewed as the single source of record or single source of truth.

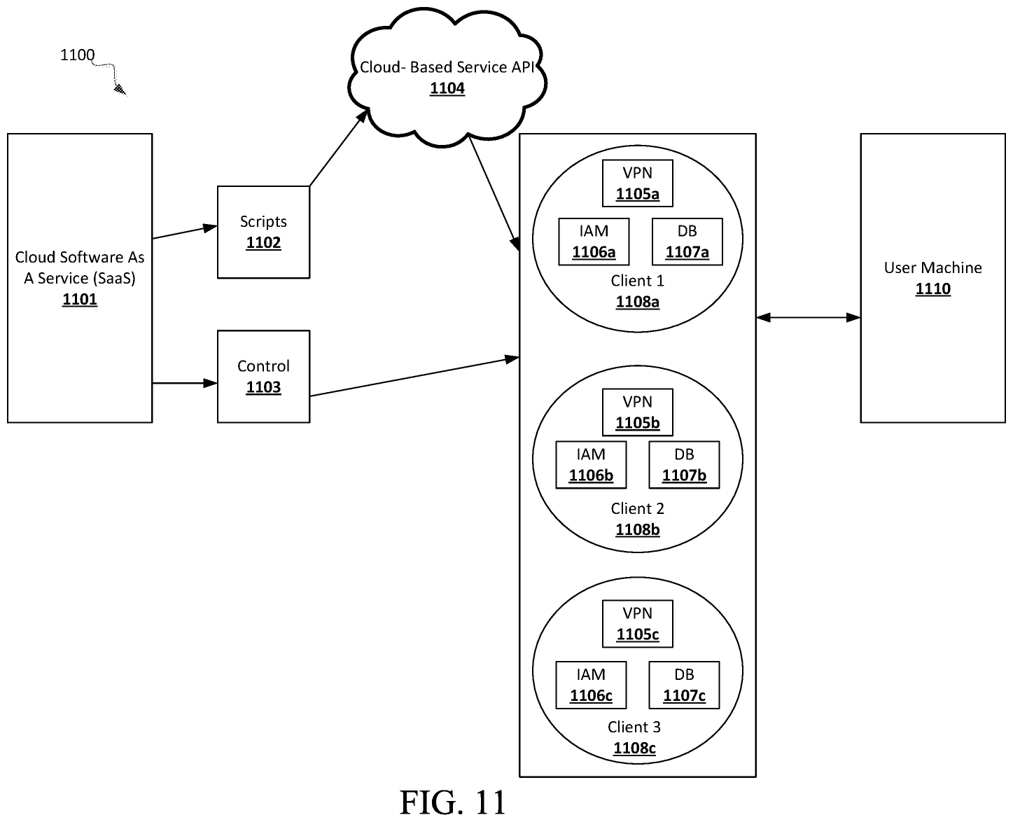

FIG. 11 illustrates an example system for automated deployment of virtual machines for a central identity access management engine. The provisioning system can preconfigure virtual machines based on customized user responses regarding access control needs to provide access to the central identity management engine. For example, as illustrated, the access control system running in the cloud 1101 can run scripts 1102 to set up one or more instances of preconfigured virtual machines, client 1 1108a, client 2 1108b, and client 3 1108c. These virtual machines 1108a-1108c each include an instance of the central identity access management engine 1106a-1106c, an instance of a database 1107a-1107c, and an instance of a virtual private network 1105a-1105c to connect the virtual machine with user machines, e.g., user machine 1110. The virtual machines can be preconfigured using cloud-based service APIs, e.g., cloud-based service 1104. Once the virtual machines are configured and deployed, users and administrators can use them to access the provisioning system to obtain provisioning information and provide access to an entity's systems.

In some implementations of the provisioning system, system managers or administrators can map fields and roles from external systems to fields and roles of the central identity access management engine using the user interfaces described above. After mapping fields and roles, all future access control changes can be automatically pushed to the identity access management engine without needing user input. In other implementations, managers or administrators may receive email notifications about new users or provisions. After the notification, in one implementation, the system may create new accounts or provisions automatically using mappings, but allow managers or administrators to verify changes through a user interface. In another implementation, the managers or administrators can create new accounts or perform assignments manually either through a user interface or through scripts.

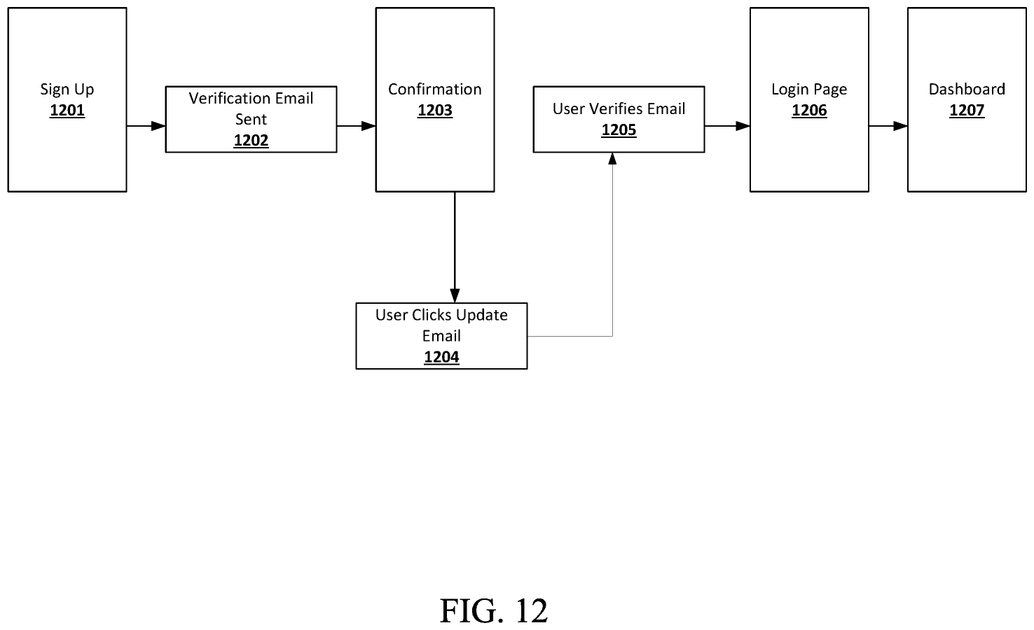

FIGS. 12-16 show example workflows of how various user interfaces can interact in the provisioning system.

FIG. 12 illustrates an example sign up flow for a provisioning system. A user may enter information to sign up on a sign up user interface 1201. A verification email may then be sent 1202. The user may provide confirmation 1203 by clicking an update email 1204. The user verifies the email 1205 and then is directed to a login page 1206 and after logging in, proceeds to the user's dashboard 1207.

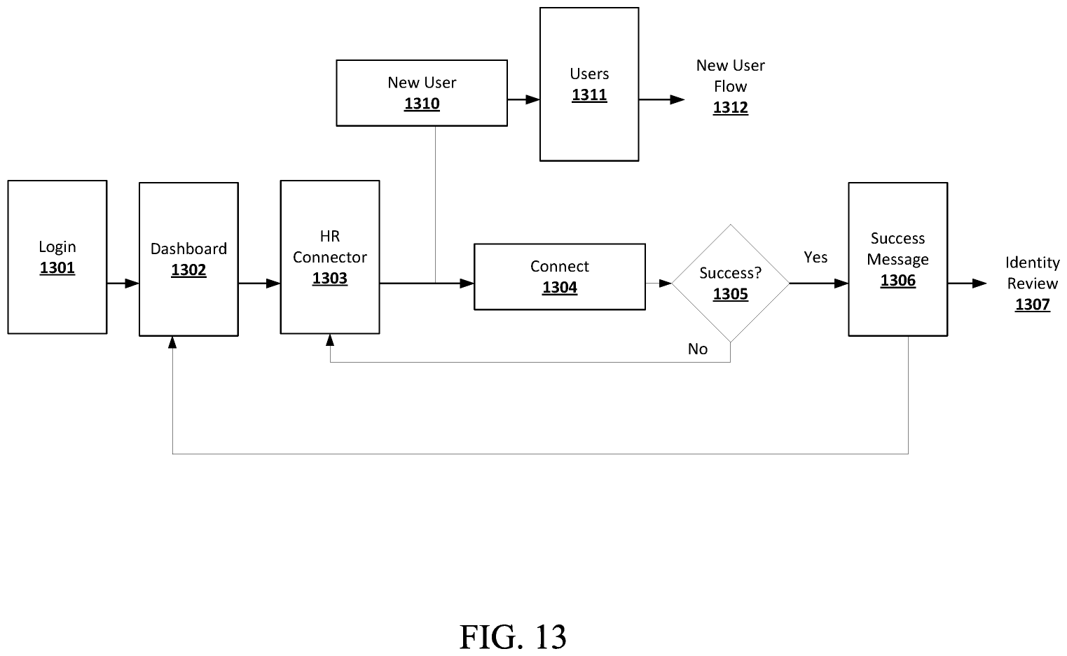

FIG. 13 illustrates an example resource creation flow of a provisioning system. After login 1301, a user can be directed to the user's dashboard 1302 where the user can create new resources. As illustrated, a user may create HR resources 1303 using an HR connector, i.e., application programming interface. Once the user has provided all of the required information for creating a new resource, as described above, the new resource can be connected in the provisioning system 1304. The system may verify success 1305 by providing a confirmation success message to the user 1306 and then proceed onto identity review 1307.

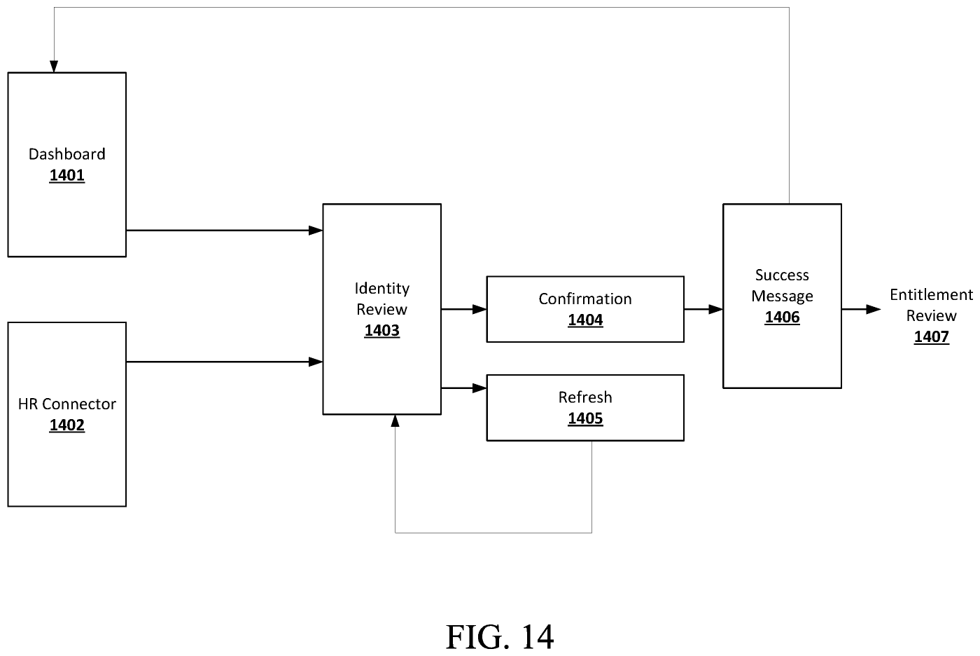

FIG. 14 illustrates an example identity review flow of a provisioning system. A user may be able to review identities either through a resource connector setup flow 1402 or directly from the user's dashboard 1401. Identity review 1403 may occur as described above with respect to FIG. 8B. Identities can be confirmed 1404, changed, or may be refreshed from an external system 1405. Once the identities have been reviewed and confirmed, the provisioning system may display a success message to the user 1406 and have the user move on to entitlement review 1407.

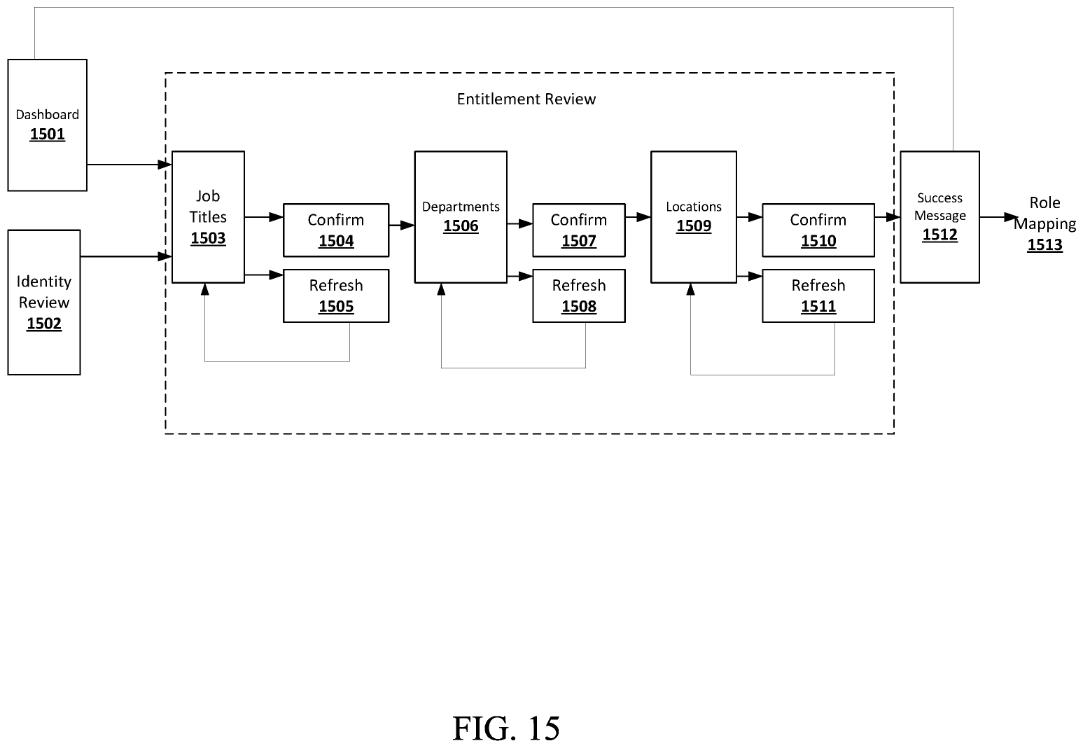

FIG. 15 illustrates an example entitlement review flow of a provisioning system. A user may be able to review entitlements either through an identity review flow 1502 or directly from the user's dashboard 1501. Entitlement review may occur as described above with respect to e.g., FIG. 7. Job titles, departments, locations, and other data associated with identities in the provisioning system may be reviewed and confirmed, changed, or refreshed from an external system. After entitlement review, the system may provide a user with a success message 1512 and forward the user to a role mapping 1513 user interface.

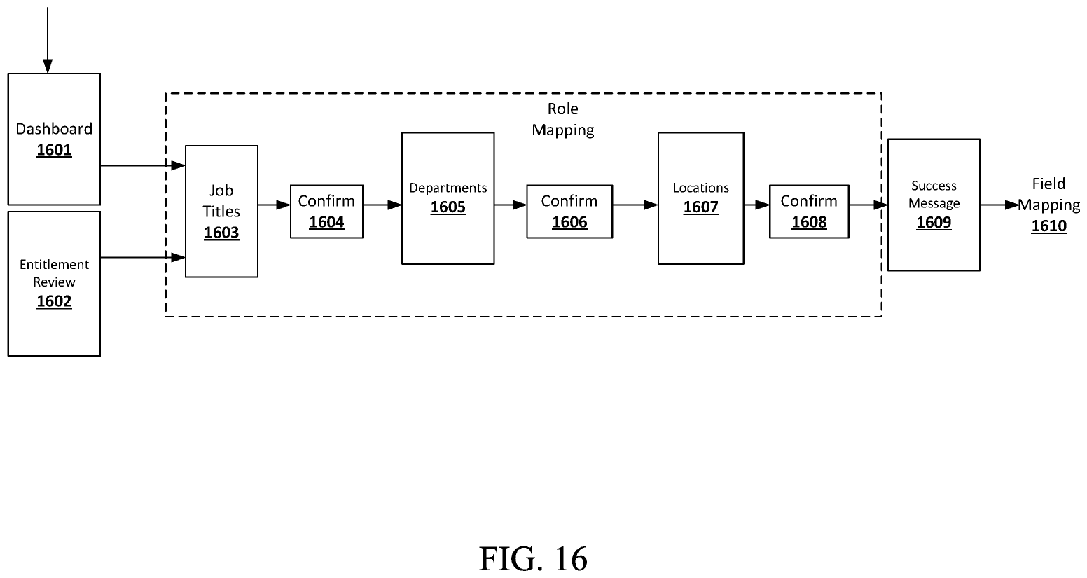

FIG. 16 illustrates an example role mapping flow of a provisioning system. A user may be able to review roles either through an entitlement review flow 1602 or directly from the user's dashboard 16. Role mapping may occur as described above with respect to, e.g., FIG. 7. Entitlement review may require reviewing the entitlements of an entity's system for the resource being connected to the provisioning system. Entitlements grant permissions to users for that particular system. Entitlement review is a step in which the user confirms which entitlements should be tracked by the provisioning system. Role mapping may include reviewing and configuring a mapping of system entitlements to roles such as job titles, departments, or locations. The user has the opportunity to specify which entitlements should be granted to an identity's user account based on role. A user may review job titles, departments, locations, and other information associated with the identities of the provisioning system. After review, the system may provide a user with a success message and then allow the user to map fields 1610 as described above.

The flows described in FIGS. 12-16 are merely example flows and other flows that allow a user to navigate from one user interface within the provisioning system to another in order to add, modify, or delete identities and access control entitlements and roles in the provisioning system are contemplated.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for provisioning access control for an entity comprising:
receiving a request to provision an external system of an entity through an identity access management engine;
acquiring credentials to connect the external system of the entity with a provisioning engine;
identifying data fields and structures from the external system;
creating mappings of the data fields or related structures between the external system of the entity and data fields or related structures of the identity access management engine using a user interface; and
importing identities from the external system to the identity access management engine using the created mappings.

2. The method of claim 1, wherein importing identities from the external system further comprises:
mapping data fields or related structures associated with the identities from the external system to data fields or related structures of the central identity access management system using the created mappings;
reviewing and confirming the mapped identities using a user interface; and
importing the mapped identities into the identity access management engine.

3. The method of claim 1, wherein creating mappings of the data fields or related structures includes direct mapping at least one field from the external system to one field in the identity access management engine.

4. The method of claim 1, wherein creating mappings of the data fields or related structures includes using at least one template to map at least one field of the external system to at least one field in the identity access management engine.

5. The method of claim 1, wherein creating mappings of the data fields or related structures includes using a complex mapping with at least one mapping rule to map at least one field of the external system with at least one field of the identity access management engine.

6. The method of claim 1, wherein creating mappings of the data fields and structures includes using artificial intelligence to detect and determine data fields or structures of the external system to map to specific fields or structures of the identity access management engine.

7. The method of claim 6, wherein creating mappings of the data fields and structures includes using machine learning or rule-based techniques to determine how the fields or structures of the external system map to fields and structure of the identity access management engine.

8. A system for provisioning access control for an entity comprising:
providing one or more application programming interfaces (APIs), to connect external systems with a central identity access management engine; and
a provision engine configured to
receive a request to provision an external system of an entity through an identity access management engine;
acquire credentials to connect the external system of the entity with a provisioning engine;
identify data fields and structures from the external system;
create mappings of the data fields or related structures between the external system of the entity and data fields or related structures of the identity access management engine using a user interface; and
import, using one or more of the provided APIs, identities from the external system to the identity access management engine using the created mappings.

9. The system of claim 8, wherein the provision engine is configured to import identities from the external system by
mapping data fields or related structures associated with the identities from the external system to data fields or related structures of the central identity access management system using the created mappings;
reviewing and confirming the mapped identities using a user interface; and
importing the mapped identities into the identity access management engine.

10. The system of claim 8, wherein the provision engine is configured to create mappings of the data fields or related structures by directly mapping at least one field from the external system to one field in the identity access management engine.

11. The system of claim 8, wherein the provision engine is configured to create mappings of the data fields or related structures using at least one template to map at least one field of the external system to at least one field in the identity access management engine.

12. The system of claim 8, wherein the provision engine is configured to create mappings of the data fields or related structures using a complex mapping with at least one mapping rule to map at least field of the external system with at least one field of the identity access management engine.

13. The system of claim 8, wherein the provision engine is configured to create mappings of the data fields and structures using artificial intelligence to detect and determine data fields or structures of the external system to map to specific fields or structures of the identity access management engine.

14. The system of claim 13, wherein the provision engine is configured to create mappings of the data fields and structures using machine learning or rule-based techniques to determine how the fields or structures of the external system map to fields and structure of the identity access management engine.
